(19) United States
(12) Patent Application Publication
(10) Pub. No.: US 2019/0068457 A1
(43) Pub. Date: Feb. 28, 2019

(54) HISTORICAL AND PREDICTIVE TRAFFIC ANALYTICS OF NETWORK DEVICES BASED ON TCAM USAGE

(71) Applicant: Cisco Technology, Inc., San Jose, CA (US)

(72) Inventors: Samar Sharma, San Jose, CA (US); Vu Nguyen, Wheeling, IL (US); Rahul Matta, San Francisco, CA (US)

(21) Appl. No.: 16/047,284

(22) Filed: Jul. 27, 2018

Related U.S. Application Data
(60) Provisional application No. 62/551,546, filed on Aug. 29, 2017.
(60) Provisional application No. 62/551,494, filed on Aug. 29, 2017.

(51) Int. Cl. H04L 12/24; G06N 99/00; H04L 12/26; H04L 29/12

(52) U.S. Cl. CPC H04L 41/147; G06N 99/005; H04L 61/2007; H04L 41/24; H04L 43/0876; H04L 41/0803

(57) ABSTRACT

A method including: in a network element that includes one or more hardware memory resources of fixed storage capacity for storing data used to configure a plurality of networking features of the network element and a utilization management process running on the network element, the utilization management process performing operations including: obtaining utilization data of a hardware memory resource of the network element; and generating, based on the utilization data, historical utilization data of the hardware memory resource.

### PRIORITY CLAIM

This application claims priority to U.S. Provisional Application. No. 62/551,546, filed Aug. 29, 2017, entitled HISTORICAL TRAFFIC ANALYTICS OF NETWORK DEVICES BASED ON TCAM USAGE, and to U.S. Provisional Application No. 62/551,494, filed Aug. 29, 2017, entitled MACHINE LEARNING TO PREDICT FUTURE NETWORK TRAFFIC MATCHING AN ENTRY OF A HARDWARE MEMORY RESOURCE OF A NETWORK DEVICE, the entirety of each of said applications is incorporated herein by reference.

### TECHNICAL FIELD

The present disclosure relates to networks, and in particular to monitoring network elements and adjusting operation of the networks elements in a network.

### BACKGROUND

End users have more communications choices than ever before. A number of prominent technological trends are currently afoot (e.g., more computing devices, more online video services, more Internet video traffic), and these trends are changing the network delivery landscape. One change is that networking architectures have grown increasingly complex in communication environments. As the number of end users increases and/or becomes mobile, efficient management and proper routing of communication sessions and data flows becomes important.

Currently, command line interlace (CLI) is one method by which network administrators can access a great deal of information with respect to their network traffic and hardware resource utilization. However, CLIs lack the ability to glean direct predictive and classificatory insights from this data.

### BRIEF DESCRIPTION OF THE DRAWINGS

FIG. 1 is a block diagram of a system for determining analytics related to a network and for generating recommendations to improve network performance based on network analytics determined for the network, according to an example embodiment.

FIG. 2 is a block diagram of a network element configured to generate and store historical data related to utilization of a hardware memory resource of the network element, according to an example embodiment.

FIGS. 3 and 4 are diagrams illustrating storage of historical data related to utilization of a hardware memory resource of the network element, according to an example embodiment.

FIG. 5 illustrates an example user configuration for obtaining historical data related to utilization of a hardware memory resource of the network element, according to an example embodiment.

FIG. 6 illustrates an example of a show system internal command, according to an example embodiment.

FIGS. 7-10 illustrate portions of example historical data obtained for different user commands, according to example embodiments.

FIG. 11 is a flowchart of a method, according to an example embodiment.

FIG. 12 is a block diagram of a network element configured to generate prediction data related to utilization of a hardware memory resource of the network element, according to an example embodiment.

FIGS. 13 and 14 are diagrams illustrating generating prediction data related to utilization of a hardware memory resource of the network element, according to an example embodiment.

FIGS. 15-17 illustrate portions of example predicting data related to usage of a hardware memory resource of the network element, according to example embodiments.

FIG. 18 is a flowchart of a method, according to an example embodiment.

### DESCRIPTION OF EXAMPLE EMBODIMENTS

### Overview

In an embodiment, a method includes: in a network element that includes one or more hardware memory resources of fixed storage capacity for storing data used to configure a plurality of networking features of the network element and a utilization management process running on the network element, the utilization management process performing operations including: obtaining utilization data of a hardware memory resource of the network element; and generating, based on the utilization data, historical utilization data of the hardware memory resource.

### Example Embodiments

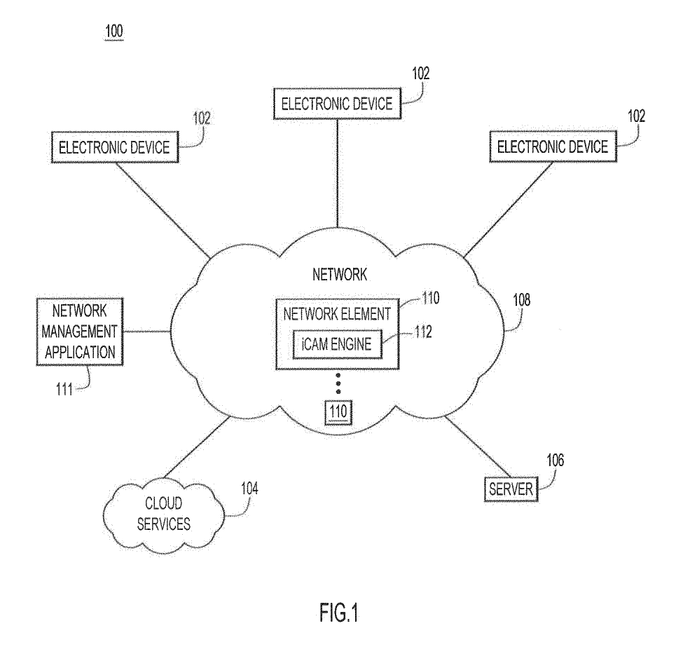

With reference made first to FIG. 1, a simplified block diagram is shown of a communication system 100 for determining analytics related to a network and for generating recommendations to improve network performance based on network analytics determined for the network. Communication system 100 can include one or more electronic devices 102, cloud services 104, and server 106. Electronic devices 102, cloud services 104, and server 106 can be in communication using network 108. Network 108 can include a network element 110, but in general, includes a plurality of network elements.

In an example implementation, cloud network 104, server 106, and network element 110, are meant to encompass network appliances, servers, routers, switches, security appliances, gateways, bridges, load balancers, processors, access points, modules, or any other suitable device, component, element, or object operable to exchange information in a network environment, or any other type of network element (physical or virtual) now known or hereinafter developed. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information. Network element 330 includes an intelligent Comprehensive Analytics and Machine Learning (iCAM) engine 112 whose functionality is described in more detail below.

The electronic device 102 is any device that has network connectivity to the network 108, and is configured to use the network 108 to send and receive data. The electronic device 102 may be a desktop computer, laptop computer, mobile wireless communication device (e.g., cellphone or smartphone), tablet, etc. The server 106 may be a web server, application server or any server configured to provide a service or function over the network 108 on behalf of one or more of the electronic devices. In an example, each electronic device 102 can request and receive data from cloud services 104 and/or server 106. Network element 110 can help facilitate the communication between electronic devices 102, cloud services 104, and server 106. To provide proper communication between the network elements of communication system 100, a network manager may determine the analytics of a network assisting with the network communications.

The iCAM engine 112 can be configured to provide analytics related to the network and to generate recommendations for the network. Said another way, iCAM engine 112 performs a utilization management process, and thus, the functions of iCAM engine 112 may be referred to herein as a utilization management process. More specifically, iCAM engine 112 can be configured to generate analytics related to usage of ternary content addressable memory (TCAM) in the network element 110 and provide a network manager with a relatively clear view of the TCAM resource utilization per networking feature, as well as how a networking configuration, especially access list entries, translates into hardware TCAM entries and which networking feature goes to which bank, how to optimize the access list entries, etc. The TCAM utilization data generated by the iCAM engine 112 can be sent, via network 108, to a network management application 111. A network manager/network administrator can study TCAM utilization data presented via the network management application 111 to determine how to effectively utilize the TCAM space and help properly configure the network and allow proper communication between the network elements of communication system 100. However, as described in more detail, the iCAM engine 112 may analyze the TCAM utilization data to generate recommendations for altering one or more configurations of one or more networking features on the network element, and in some embodiments, automatically implement those configuration modifications to improve utilization of the TCAM as well as improve overall performance of the network element 110 in the network 108. Further still, the iCAM engine 112 may send the TCAM utilization data to the network management application 111 and the network management application 111 may perform the analysis on the TCAM utilization data to generate recommendations to alter the configurations of one or more networking features on the network element 110, or automatically configure the network element 110 with the configuration modifications.

For purposes of illustrating certain example techniques of communication system 100, the following foundational information may be viewed as a basis from which the present disclosure may be properly explained.

Networking architectures continue to grow increasingly complex in communication environments. As the number of end users increases and/or becomes mobile, efficient management and proper routing of communication sessions and data flows becomes critical. One particular type of network Where efficient management is crucial is data centers. Data centers serve a large portion of the Internet content today, including web objects (text, graphics, Uniform Resource Locators (URLs) and scripts), downloadable objects (media files, software, documents), applications (e-commerce, portals), live streaming media, on demand streaming media, and social networks.

Currently, network managers do not have an overall view of how many entries of a hardware memory resource, such as TCAM or static random access memory (SRAM), are being used with respect to various networking features or combination of networking features. Moreover, network managers often find it difficult to understand how to improve a configuration, especially for a data center. For example, for the access control list (ACL) Classification TCAM, some network managers do not have a clear overall view of the resource and how the access list entries translate into hardware TCAM entries, and more specifically, how the TCAM is utilized per features such as Router-ACL (RACL), virtual local area network (VLAN)-ACL, (VACL), Port-ACL (PACL), or a combination of RACL+VACL and many more L3/L2 ACL/QoS features. Moreover, it is useful to know which networking feature goes to which bank, how to optimize the access list entries, etc. Often, a network manager tries various combinations until they come up with a configuration that fits in the hardware. This can be time consuming and frustrating. As a result, some network managers may have difficulty determining which feature/combination is consuming more hardware resources and/or which TCAM/bank is loaded with more feature resources. Hence, there is a need for a system and method to determine analytics related to (network elements) in a network, and to use those analytics to generate recommendations for improving the (network elements in the) network. When reference is made herein to determining analytics for a network, it is to be understood that this means determining analytics for one or more network elements in the network. Moreover, when it is referred to herein to generating recommendations for the network, it is to be understood that this means generating one or more recommendations for changing a configuration of one or more network elements of the network.

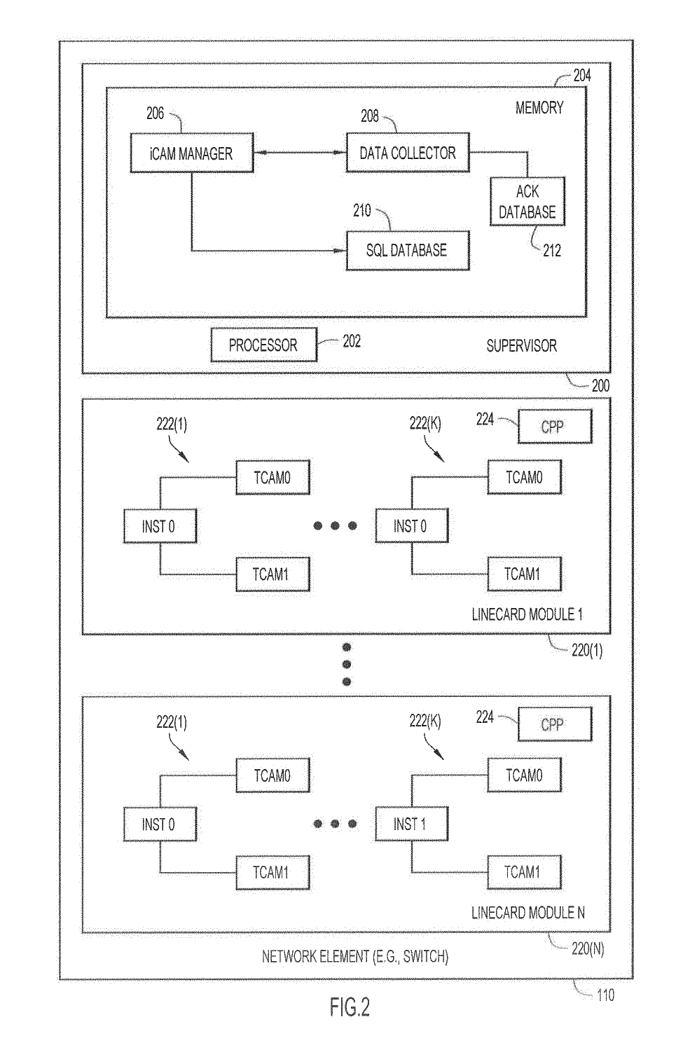

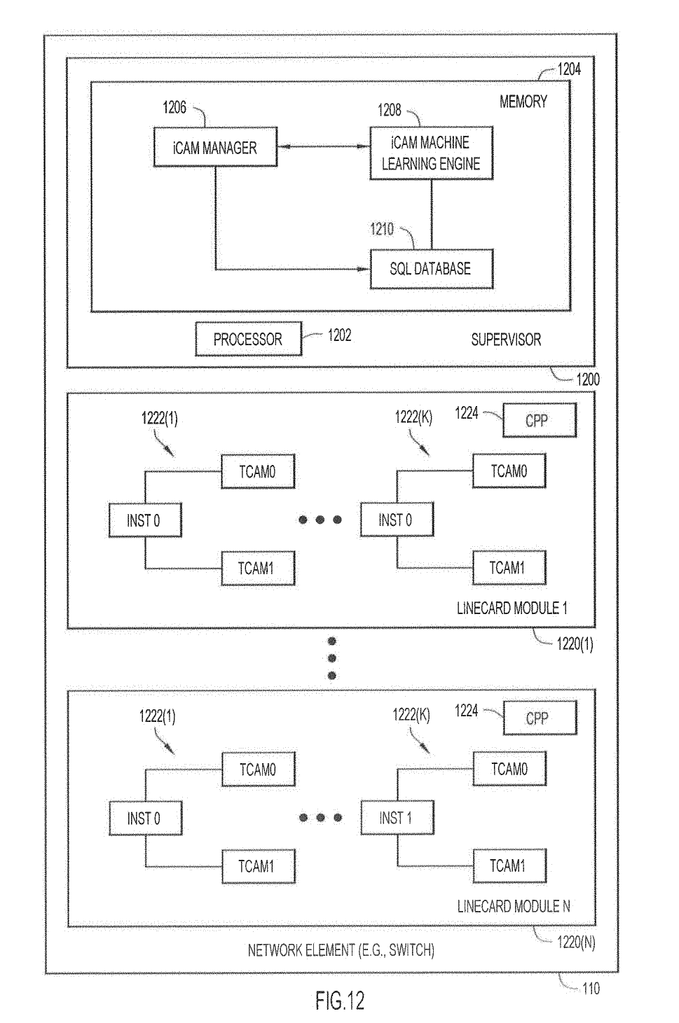

A communication system, as outlined in FIG. 1, can resolve these issues (and others). Communication system 100 may be configured to determine analytics related to a network, and to generate recommendations based on the analytics. In a specific example, communication system 100 can be configured to include an iCAM engine (e.g., iCAM engine 112) on a supervisor engine (e.g., supervisor 200 illustrated in FIG. 2 or supervisor 1200 illustrated in FIG. 12) or located in some other network element. The iCAM engine 112 can be configured to interact with various processes (e.g., driver software for a TCAM portion of a network) to collect the hardware resource utilization data. The hardware (memory) resource utilization data can be processed and summarized on a per feature basis. The processed and summarized hardware resource utilization data can be communicated to a network manager (or network manager) to provide analytics related to the network, and may be used to recommend changes to the network that may improve the network. The processed and summarized hardware resource utilization data and the recommended changes can be communicated to a network manager (or network manager) to try and improve the performance of the network. The analytics and recommendations can be used by the network manager to help determine how the configuration of the network can be improved, especially access list entries translate into hardware TCAM entries and which feature goes to which bank, how to optimize the access list entries, etc.

As a result, network managers are able to receive a consolidated clear view of how a configuration, especially access list entries, translate into utilization of hardware resources, that is the number of utilized TCAM entries, and which networking feature goes to which bank, how to optimize the access list entries, etc. Based on the feature resource usage, the network manager can attempt to effectively use the TCAM hardware space. The summarized hardware resource utilization data can also provide the network manager with an indication of which feature goes to which TCAM/bank, how each forwarding engine is loaded with features, total used and free entries per forwarding engine and TCAM/bank, how the access list entries translate into hardware TCAM entries and which feature goes to which bank, how to optimize the access list entries, and other information or data that may help a network manager view or otherwise determine analytics related to the network and improve the performance of the network. By standardizing Application Programming Interfaces (APIs) and associated messages, the same information can be leveraged across other networks. The above examples are only illustrative examples and other means or methods may be used to determine analytics related to a network.

Generally, communication system 100 can be implemented in any type or topology of network. Network 108 represents a series of points or nodes of interconnected communication paths for receiving and transmitting packets of information that propagate through communication system 100. Network 108 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication. Network 108 can include any number of hardware or software elements coupled to (and in communication with) each other through a communications medium. In an example, network 108 is a data center and iCAM engine 112 can help provide analytics and one or more recommendations to help improve the performance of the data center. In another example, network 108 can include one or more platforms. The examples, particular arrangements, configurations, etc. described in the present disclosure can be applied to one or more networks or platforms.

In communication system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/internet Protocol (TCP/IP), user datagram protocol/IP (UDP/IP)). Additionally, radio signal communications over a cellular network may also be provided in communication systems 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

As used herein, a ‘network element’ is meant to encompass any of the aforementioned elements, as well as servers (physical or virtually implemented on physical hardware), machines (physical or virtually implemented on physical hardware), end-user devices, routers, switches, cable boxes, gateways, bridges, load-balancers, firewalls, inline service nodes, proxies, processors, modules, or any other suitable device, component, element, proprietary appliance, or object operable to exchange, receive, and transmit information in a network environment. These network elements may include any suitable hardware, software, components, modules, interfaces, or objects that facilitate the synonymous labels operations thereof. This may be inclusive of appropriate algorithms and communication protocols that allow for determining analytics related to a network.

In one implementation, network elements implementing the determination/generation of analytics related to network features and recommendations based on the analytics described herein may include software to achieve (or to foster) the functions discussed herein fur providing and processing when the software is executed on one or more processors to carry out the functions. This could include the implementation of instances of modules (e.g., iCAM engine 112) and/or any other suitable element that would foster the activities discussed herein. Additionally, each of these elements can have an internal structure (e.g., a processor, a memory element, etc.) to facilitate some of the operations described herein. In other embodiments, these functions for the determination of analytics and recommendations based on the analytics may be executed externally to these elements, or included in some other network element to achieve the intended functionality. Alternatively, network elements may include software (or reciprocating software) that can coordinate with other network elements in order to achieve determination of analytics related to a network described herein. In still other embodiments, one or several devices may include any suitable algorithms, hardware, software, components, modules, interfaces, or objects that facilitate the operations thereof.

In regards to the internal structure associated with communication system 100, electronic devices 102, cloud network 104, server 106, and network element 110 can each include memory elements for storing information to be used in the operations outlined herein. Each of electronic devices 102, cloud network 104, server 106, and network element 110 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable time frame. Any such storage options may also be included within the broad term ‘memory element’ as used herein.

In certain example implementations, the recommendation system based on network analytics functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein. In some of these instances, one or more memory elements can store data used for the operations described herein. This includes the memory element being able to store instructions (e.g., software, code, etc.) that are executed to carry out the activities described herein. The processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving the recommendation system based on network analytics functions, as outlined herein. Additionally, each of these devices may include a processor that can execute software or an algorithm to perform the functions of as described herein. These devices may further keep information in any suitable memory element (random access memory (RAM), ROM, EPROM, EEPROM, ASIC, etc.), software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

In an example implementation, network elements of communication system 100 may include software modules (e.g., iCAM engine 112) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in sonic other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, electronic devices 102, cloud network 104, server 106, and network element 110 each may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic devices 102 can include user devices. Cloud network 104 may generally be defined as the use of computing resources that are delivered as a service over a network, such as the Internet. The services may be distributed and separated to provide required support for electronic devices. Typically, compute, storage, and network resources are offered in a cloud infrastructure, effectively shifting the workload from a local network to the cloud network. Server 106 can be a network element such as a physical server or virtual server and can be associated with clients, customers, endpoints, or end users wishing to initiate a communication in communication system 100 via some network (e.g., network 108). The term ‘server’ is inclusive of devices used to serve the requests of clients and/or perform some computational task on behalf of clients within communication systems 100.

According to embodiments presented herein, a network element 110 is configured to generate a historical perspective of the usage of TCAM. In other words, what did the TCAM table look like 5 days ago, 5 weeks ago, how much traffic was coming into the table X days ago, etc. Such historical knowledge provides better visibility into system performance and to understand network operations, and where network traffic is going, and when, etc.

FIG. 2 is a block diagram of network element 110 configured to generate and store historical data related to utilization of a hardware memory resource of the network element, according to an example embodiment. With reference to FIG. 2, to this end, the network element 110 includes a supervisor module 200 and a plurality of linecard modules 220(1)-220(N). The supervisor module includes a processor (or multiple processors) 202 and memory 204. Memory 204 stores instructions executable by the processor for an iCAM manager 206, a data collector 208, a SQL, database 210 and an acknowledgement (ACK) database 212.

Each linecard module 220(1)-220(N) includes a plurality of instances of a pair of TCAMs (TCAM0 and TCAM1) shown at 222(1)-222(K) and a control path processor (CPP) 224.

There are other components to the network element but those other components do not relate to the techniques disclosed herein, and thus for simplicity they are omitted from the diagram of FIG. 2.

The supervisor module 200 monitors activity of the linecard modules 220(1)-220(N) to collect and store data about TCAM usage. A user configures a global monitoring interval and/or a number of intervals to store in history. The user enables monitoring, for example, for a specified class, module, inst. Examples of configurations are described below.

The iCAM Manager 206 parses and persistent storage service (PSS) the configuration, then calls Data Collector 208 to set the new monitoring parameters. The SQL database 210 stores the TCAM data according to the user configurations.

iCAM Manager 206 parses and PSS the configuration, then calls Data Collector 208 to enable monitoring for this class, module, instance (inst). The Data Collector 208 checks if this is the first (module, inst) for this class. If the timer already exists and data collecting is in progress, a new interval is configured. If the timer already exists and data collecting is not in progress, the current timer is stopped and the new interval is configured.

The Data Collector 208 sends a data request for the specified class, module, inst and adds an entry into an ACK database to keep track of linecard responses. This may not be necessary if only 1 request per module, inst, is sent. However, a single request may be sent for multiple modules.

Upon receiving the response from the linecard, the Data Collector 208 checks if a more_data flag is set before removing the more_data flag from the ACK database, and inserts the received data into SQL database 210.

Once all the data is received from the linecard, the ACK database entry is deleted and the iCAM Manager 206 is notified. The timer is start/restarted.

The Data Collector 208 stops the timers for all classes, configures the new interval, and restarts the timers. The Data Collector 208 also purges history according to new configuration for num_intervals.

The configuration of the network element 110 shown in FIG. 2 enables periodic collection of data about TCAM entries into the network element itself and stored in a database on the switch. The user can specify the periodicity and how often to store/take snapshots of the TCAM data. The user can also specific how often and how long to keep the data.

An example format for command line interface (CLI) to configure how often and how long to monitor TCAM information:
*(Optional) icam monitor interval <interval-hours> num_intervals <number-of-intervals> duration <duration-len>
icam monitor resource {acl_tcam|fib_tcam} module <module-number> inst <instance-number>
icam monitor entries acl module <module-number> inst <instance-number>

If interval and num intervals are not specified, a default may be used, e.g., 1 hour intervals, and with a history of 7 days (168 intervals).

Both the “show icam resources” and “show icam entries” CLI have a history option. The history option for show icam resources {acl_tcam|fib_tcam} displays the snapshots o stats over the last n number of intervals. The history option for the show icam entries {acl|multicast} displays the cumulative traffic stats and average rate in packets per second (pps) during the last n number of intervals.

The history output can be sorted and filtered.

Examples of historical data include:
TCAM usage per feature
TCAM hits per feature
   Sorted
   Searchable
   Top/bottom %
Last X historical intervals (user specified periodicity)
Ability to define number of intervals to be saved
Ability to define size of each interval
Average of last X intervals (over the last 5 days, on average how much of the TCAM was used for a user-specified type of feature)

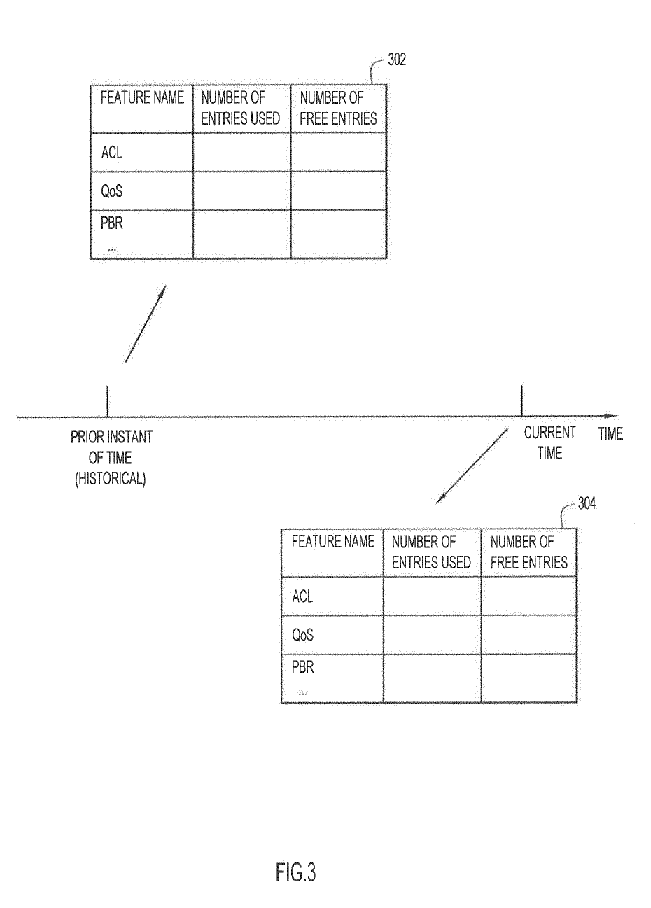

Reference is now made to FIG. 3 for a pictorial representation of the historical TCAM data collection techniques according to one embodiment. FIG. 3 shows that TCAM usage data indicating, for each feature of multiple features (e.g., Access Control List (ACL), Quality of Service (QoS), Policy-Based Routing (PBR,), etc.) is stored for a current, as well as for a prior instant of time. FIG. 3 shows data 302 and data 304. Data 302 is representative of historical TCAM usage data for a prior instant of time, and data 304 is representative of current TCAM usage data at a current instant of time. For each of one or more networking features (ACL, QoS, PBR, etc.), the data 302 and 304 include a field for each of: a number of entries used, and a number of free entries. The number of entries used indicates how many TCAM entries that feature is using. The number of free entries indicates how many free entries there are from that feature.

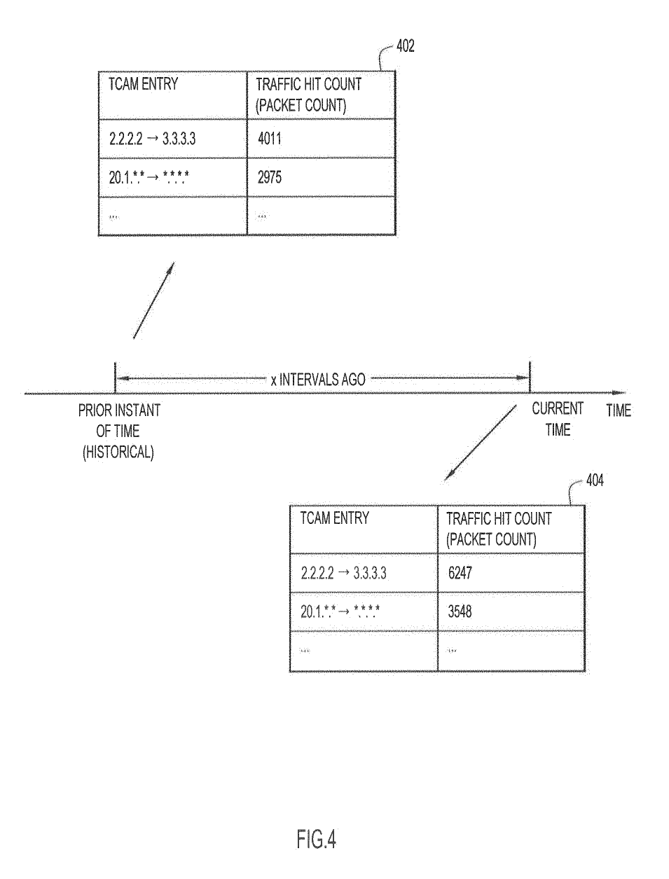

FIG. 4 shows another example of historical data collection techniques. In this example, for each TCAM flow entry (5-tuple), traffic hit count is stored both at the current time and at a predetermined number of time intervals in the past. For example, FIG. 4 shows that for the flow 2.2.2.2→3.3.3.3, “x” intervals ago, the packet count for that flow was 4011, whereas at the current time, the packet count is 6247. FIG. 4 shows data 402 and data 404. Data 402 represents an example of historical traffic hit count data at a prior instant of time, and data 404 represents an example of traffic hit count data at a current instant of time.

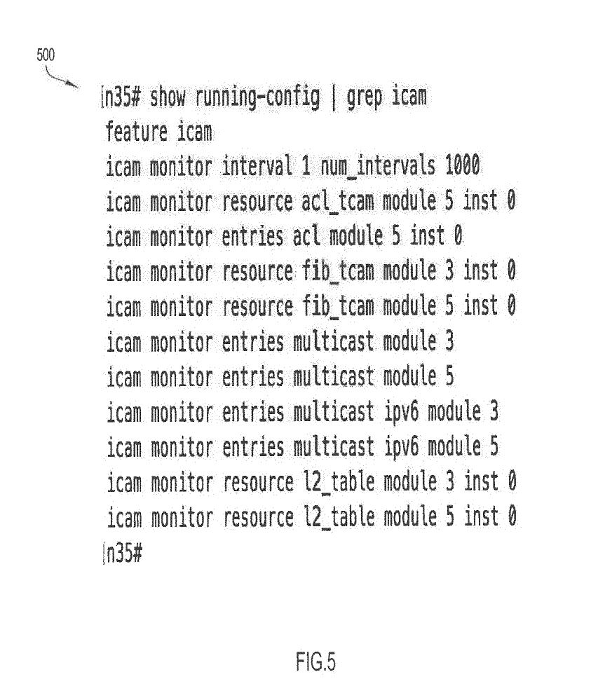

FIG. 5 shows an example configuration, according to an example embodiment. For example, a user may enter “show running-config|grep icam” command into, e.g., the CLI, to view the running configuration for the iCAM. The example configuration shows a number of TCAM entries and TCAM sources for which iCAM monitoring is enabled. In the example configuration shown in FIG. 5, the iCAM monitor interval (e.g., interval-hours) is set to 1, and the global interval history (e.g., a number of intervals in iCAM monitor history) is set to 1000. The remaining configuration statements shown in FIG. 5 indicate what resource are to collect TCAM usage data. For example, “icam monitor resource acl_tcam module 5 inst 0” and “icam monitor entries acl module 5 inst 0” means that ACL TCAM entries are to be collected from module 5, instance 0, and that data is to be monitored. Similarly, “icam monitor resource fib_tcam module 3 inst 0” means that the forwarding information base (fib) TCAM of module 3, instance 0” is to be monitored.

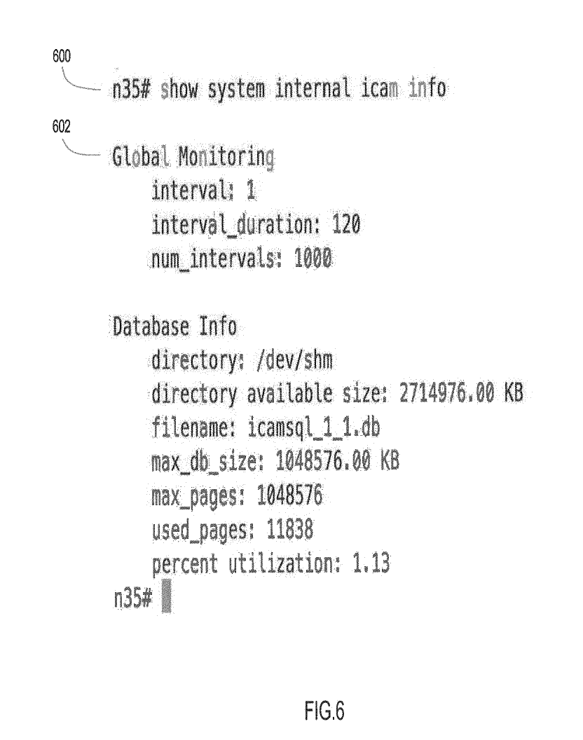

FIG. 6 provides an example show system internal information command 600, according to an example embodiment. As shown in FIG. 6, the “Global Monitoring” statement 602 includes an interval set to 1 (e.g., 1 hour), an interval duration set to 120 (e.g., 120 seconds), and an interval number set to 1000. The “Datable Info” statement specifies the attributes of the database/storage to be used for monitored TCAM data.

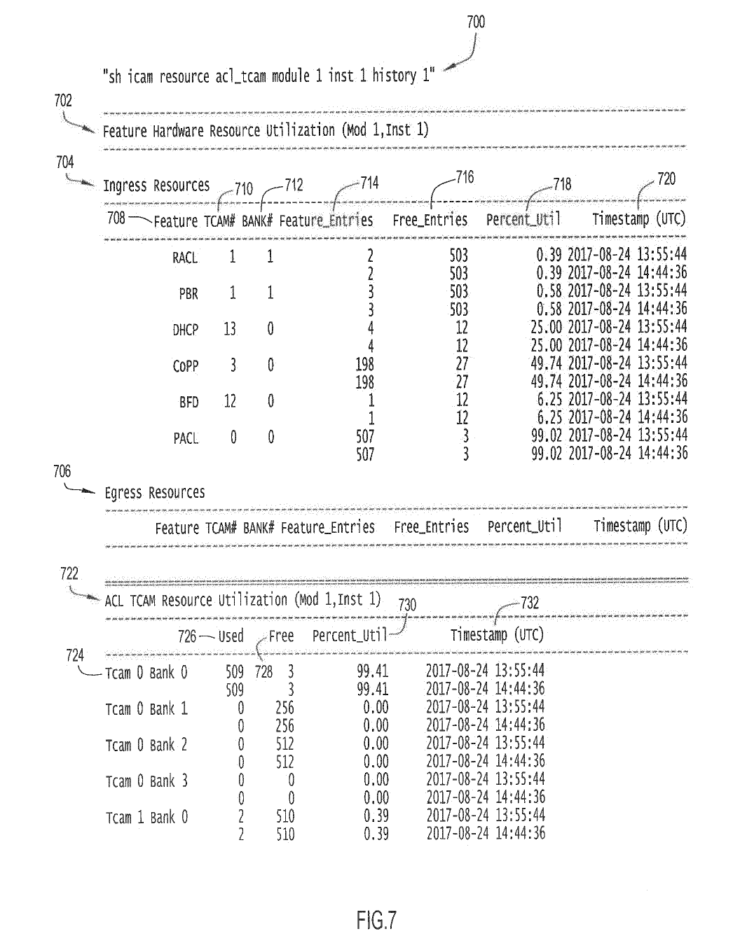

FIGS. 7-10 illustrate portions of example historical data obtained for different user commands, according to example embodiments.

FIG. 7 illustrates example historical data 700 displayed for a show command “sh icam resource acl_tcam module 1 inst 1 history 1”, according to an example embodiment. In this example, hardware memory resource (e.g., TCAM) utilization is shown 702 for a network element on which a plurality of networking features 708 are configured, including RACL, PBR, Dynamic Host Configuration Protocol (DHCP), Control Plane Policing (CoPP), Bidirectional Forwarding Detection (BFD), and PACL. For each of the features listed, and for each of Ingress Resources and Egress Resources, the data 704 and data 706 is collected that includes a field for each of: TCAM# 710, Bank# 712, Feature Entries 714, Free Entries 716, Percent Utilization (Percent Util) 718, and Timestamp (UTC) 720. In addition, ACL TCAM resource utilization data 722 is collected, including data per TCAM per hank 724. For each per TCAM per bank 724, the data 722 includes field for each of: Used (Entries) 726, Free (Entries) 728, Percent Utilization (Util) 730, and Timestamp (UTC) 732.

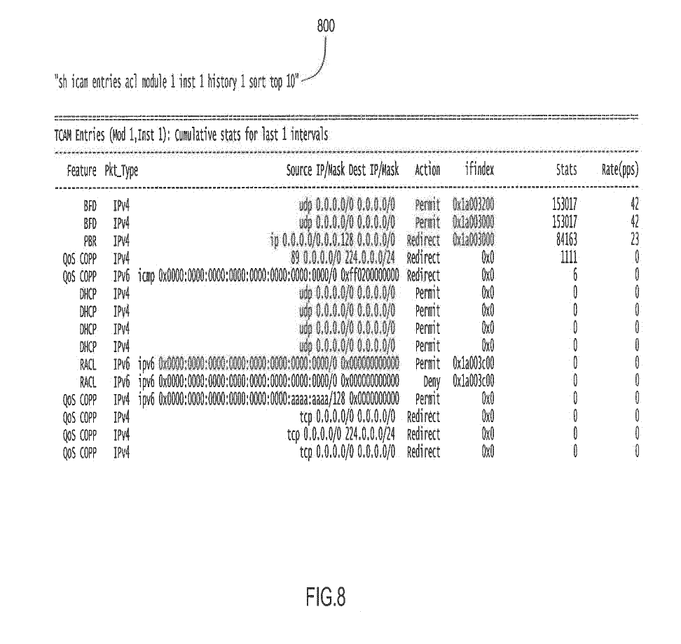

FIG. 8 illustrates example sorted historical data 800 displayed for the show command “sh icam entries acl module 1 Inst 1 history 1 sort top 10”, according to an example embodiment.

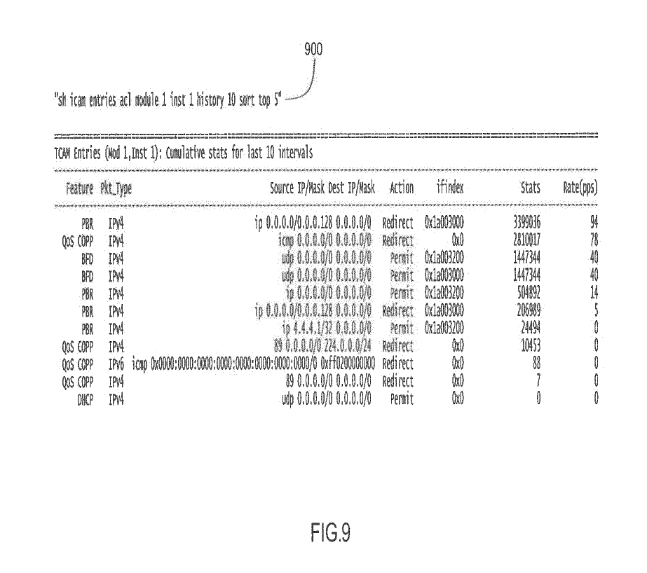

FIG. 9 shows example sorted historical data 900 displayed for the show command “sh icam entries acl module 1 inst 1 history 10 sort top 5”, according to an example embodiment.

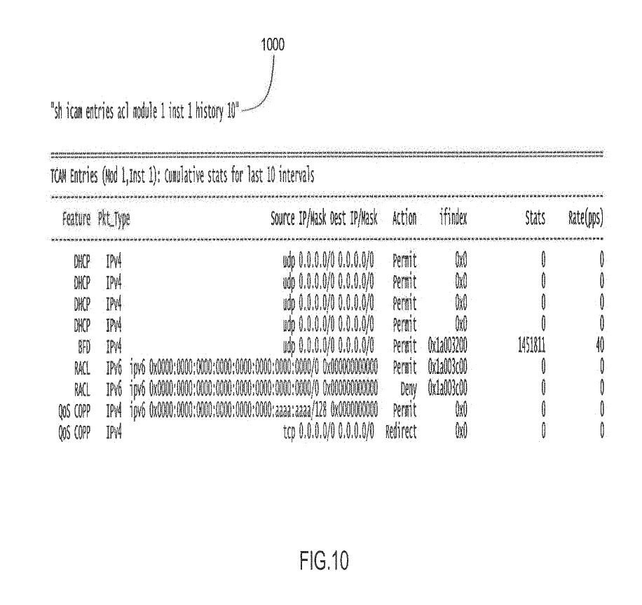

FIG. 10 shows example historical data displayed 1000 for the show command “sh icam entries ad module 1 inst 1 history 10”, according to an example embodiment.

The historical data may be further processed in various ways such as:
Filter the data by networking feature type
Sort the data in descending/ascending order by traffic statistics
Display only top or bottom X % of entries based on the traffic statistics

An example of an operational flow to generate the historical traffic analytics includes: receiving from a user a configuration of historical analytics to be generated in the network element; storing over time data in a database in a memory of the network element associated with use of a hardware memory resource of the network element based on the configuration; retrieving from the database historical traffic analytics data. The configuration may specify how often (on what periodic interval) and for how long to store the historical traffic analytics data. The retrieving step may involve responding to a user interface command, e.g., CLI, command that specifies presentation parameters of the historical traffic analytics data.

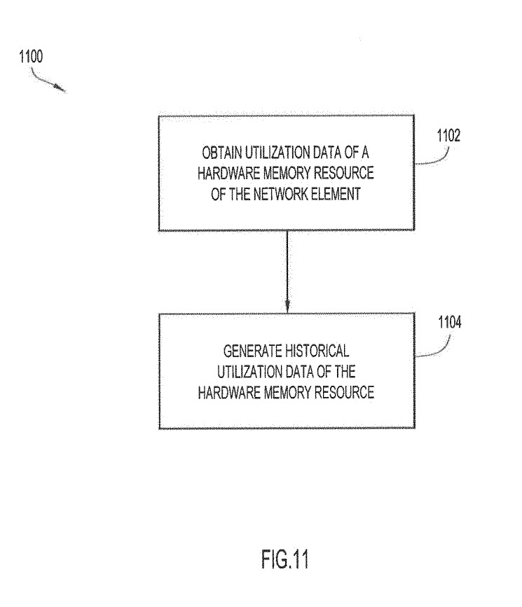

FIG. 11 shows a flow Chart for a method 1100, according to an example embodiment. The method 1100 may be executed in a network element (e.g., network element 110), which includes one or more hardware memory resources of fixed storage capacity, such as a TCAM. The one or more hardware memory resources are used to configure a plurality of networking features implemented on the network element. At 1102, utilization data of a hardware memory resource of the network element is obtained, according to one or more configurations. At 1104, historical utilization data of the hardware memory resource is generated.

In accordance with a further embodiment, presented herein are techniques for integrating machine learning algorithms natively into the infrastructure of network elements in order to predict future behavior of the network elements.

Based on utilization data accumulated over a period of time (e.g., at 1102), a prediction of future utilization data of the hardware memory resource for traffic that will flow through the network element in the future, may be generated. Based on the future utilization data, configuration data may be generated. The configuration data may be data that is used to configure a network element. For example, the configuration data may be used to adjust or alter one or more configurations of one or more networking features on the networking element. The future utilization data may be analyzed, and based on the analysis, the configuration data may be generated. For example, if the future utilization data that is generated is determined to be above a threshold, a determination may be made that a first configuration is to be implemented. If the future utilization data that is generated is determined to be at or below the threshold, a determination may be made that a second configuration is to be implemented. The configuration data may be used for helping improve or changing the performance of the networking element and/or the network. For example, the configuration data may be used to improve utilization of one or more hardware memory resources. This may include, for example, one or more of: allowing a merge of one of more hardware memory resources, allowing chaining of memory banks in the one or more hardware memory resources, or disallowing cross-product by moving features to different hardware interfaces of the network element or tables maintained by the hardware memory resources. Based on the configuration data, the network element may be automatically configured. For example, if a first configuration is to be implemented, the network element may be automatically configured in accordance with the first configuration.

FIG. 12 is a block diagram of a network element configured to generate prediction data related to utilization of a hardware memory resource of the network element, according to an example embodiment. Referring to FIG. 12, to this end, the network element 110 includes a supervisor module 1200 and a plurality of linecard modules 1220(1)-1220(N). The supervisor module includes a processor (or multiple processors) 1202 and memory 1204. Memory 1204 stores instructions executable by the processor for an iCAM manager 1206, an iCAM Machine Learning Engine 1208 and a SQL database 1210.

Each linecard module 1220(1)-1220(N) includes a plurality of instances of a pair of TCAMs (TCAM0 and TCAM1) shown at 1222(1)-1222(K) and a control path processor (CPP) 1224.

There are other components to the network element but those other components do not relate to the techniques disclosed herein, and thus for simplicity they are omitted from the diagram of FIG. 12.

The supervisor module 1200 monitors activity of the linecard modules 1220(1)-1220(N) to collect and store data about TCAM usage. The iCAM Machine Learning Engine 208 interfaces with the database 1210 and runs machine learning algorithms. iCAM Manager 1206 invokes the iCAM Machine Learning Engine 1208. The iCAM Machine Learning Engine 1208 may act as server providing machine learning (ML) data to iCAM Manager 1206.

A user issues a show command for ML predictions for a class, module, inst, prediction type. The iCAM manager 1206 parses the user inputs and validates against the configuration. The iCAM manager 1206 displays the results from the ML engine 1208.

CLI commands for showing ML predictions may include:
show icam prediction resource {acl_tcam|fib_cam} module <module-number> inst <instance-number> <year> <month> <day> <HH:MM:SS>
show icam prediction entries acl module <module-number> inst <instance-number> <year> <month> <day> <HH:MM:SS> [top <x>]

The ML engine 1208 may predict per-feature TCAM usage, and predict the traffic per TCAM entry. The ML engine 1208 may use supervised learning, regression tree algorithms and then use the results of regression tree algorithms to normalize the data to suit the specific application.

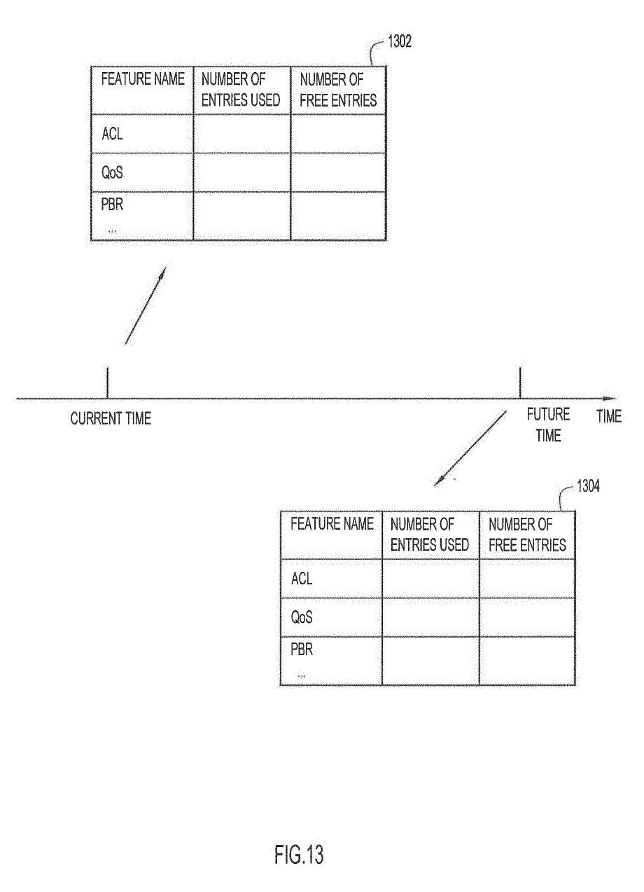

FIG. 13 graphically depicts how the ML engine 1208 may use TCAM usage data for a current time, and for any given period of time, to predict per-feature TCAM usage data at a future time, e.g., for access control list (ACL), Quality of Service (QoS) and policy-based routing (PBR), etc. FIG. 13 shows hardware resource utilization data for a current instant of time 1304 and data predicted hardware resource utilization data 1304 derived from historical hardware resource utilization data accumulated over prior instants of time.

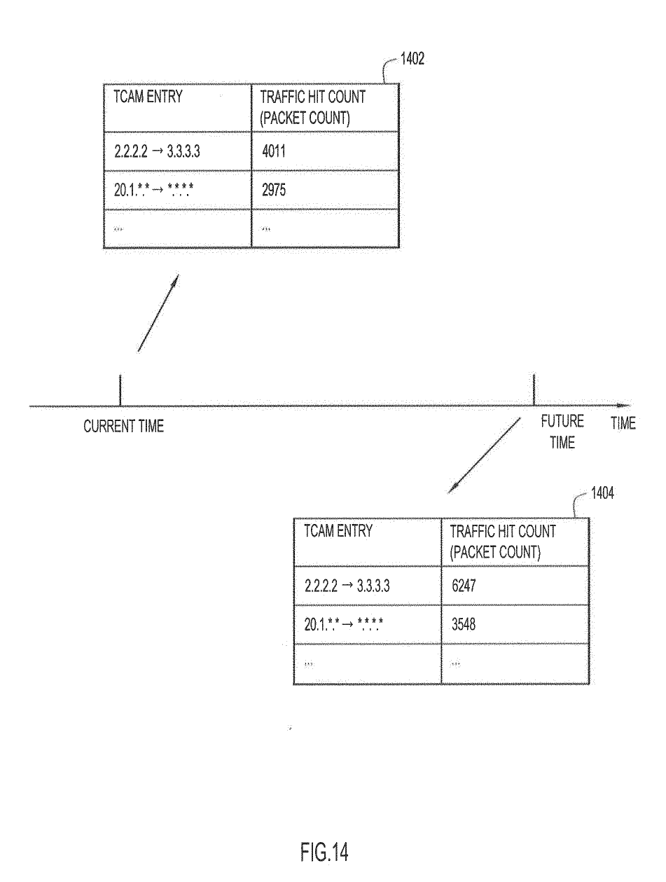

FIG. 14 graphically depicts how the NIL engine may use TCAM entries of hit counts for individual flows (5-tuples) to predict hit counts for those flows in the future. FIG. 14 shows hit count data 1402 for a current instant of time and predicted TCAM entry data 1404 in the future, derived from historical hit count data accumulated over prior instants of time.

With reference to FIG. 12, the following is a description of an example implementation of machine learning based predictive analysis on a network switch. The first step is to obtain the relevant data from the database 1210. Two general CLI commands may be used: traffic and resource. In the traffic scenario, potentially thousands of records are stored, each of which contains a source and destination IP address, the number of packets travelling across the route at a given time, as well as a number of other metadata. In the resource scenario, each record contains the resource type, the networking feature utilization, as well as a number of other metadata.

Subsequently, the following algorithm is performed on each row of data. With the entire set of relevant data, the Iterative Dichotomiser 3 (ID3) algorithm iterates through each unvisited attribute in the feature set (a refined set of time-based attributes such as “time of day” and “month. of year”, etc.). The ID3 algorithm is used to generate a decision tree from a dataset, The hypothesis is that the selected attributes would have the highest positive influence in predicting a target variable (packet count, hardware resource utilization, etc.).
1. On each iteration, calculate the entropy of the intersection subset for each attribute.
2. Select the subset which results in the highest reduction in entropy (indicative of the data homogeneity)
3. Recursively partition the data in a manner described in steps 1 and 2 until the selected subset's homogeneity reaches a predetermined threshold.
4. Return a normalized average of the remaining data points, The final subset obtained contains an array of items which are presumed to be the best predictors of the target data type (per-TCAM usage, per-entry traffic count, etc.). In order to eliminate the bias of outliers, the data is normalized based on a computed mean squared error (MSE), and a mathematical average is returned as the predicted value.

One or more supervised machine learning techniques may be applied in order to predict a target variable of future input samples. For example, C4.5, a decision tree algorithm used for classification and regression may be used. The algorithm could be applied in the following way;

For example, considering the traffic scenario described above, relevant data may be represented as a set S={s1, s2, s3, . . . }, where si consists of a p-dimensional vector (x1, x2, x3, . . . xp−1, ti). In this case, attribute xj may be “source IP”, “destination IP”, “month of the year”, “hour of the day”, “packet type”, etc. Variable ti is the target variable, which, for example, is the flow-specific hit count at a particular time. The C4.5 algorithm can be employed to create a decision tree such that, with a future p−1 dimensional input vector f=(f1, f2, f3, . . . , fp−1), a predicted value t for the input vector f may be generated.

A starting point may be at the root of the tree. C4.5 selects the attribute x which splits the set S most homogenously. A common metric for determining homogeneity is information gain, which can also be defined in our case as the reduction in standard deviation. In other words, C4.5 selects the attribute whose result set, which includes the corresponding attribute x from each vector si in s, offers the highest reduction in standard deviation. The algorithm then recurs on the rest of the attributes until either a) the reduction in standard deviation reaches some threshold (5% of S, for example); or b) all of the attributes have been visited.

After creating a decision tree which characterizes the relative influences of the input attributes, a future input vector f may passed through the structure. A measure of center on the resulting set may be returned as the predicted value. To avoid the bias of outliers, the median may be utilized.

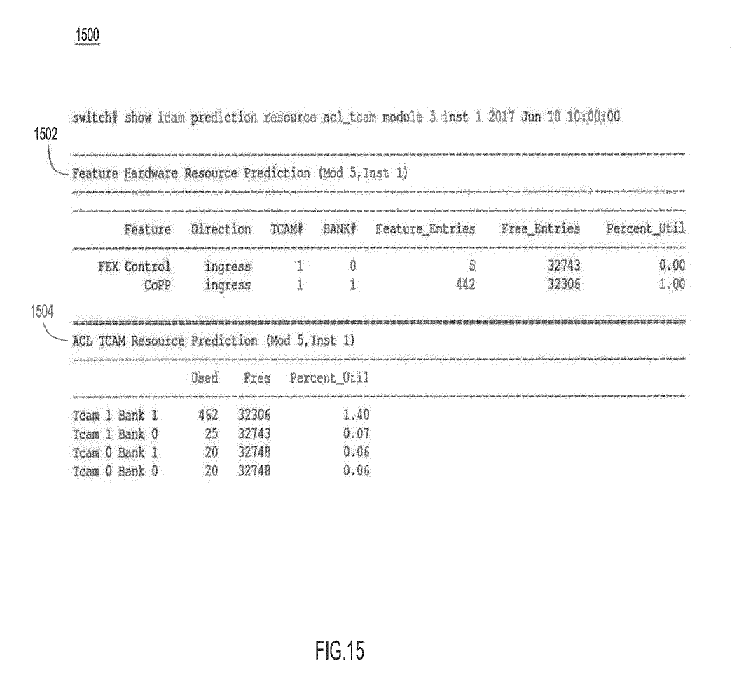

FIGS. 15-17 illustrate portions of example predicted data related to usage of a hardware memory resource of the network element, according to example embodiments.

FIG. 15 shows an example of an ACL prediction. The example ACL prediction 1500 includes predicted feature hardware resource data 1502 for the “FEX Control CoPP” networking feature and predicted ACL TCAM resource data 1504 in several TCAMs and banks.

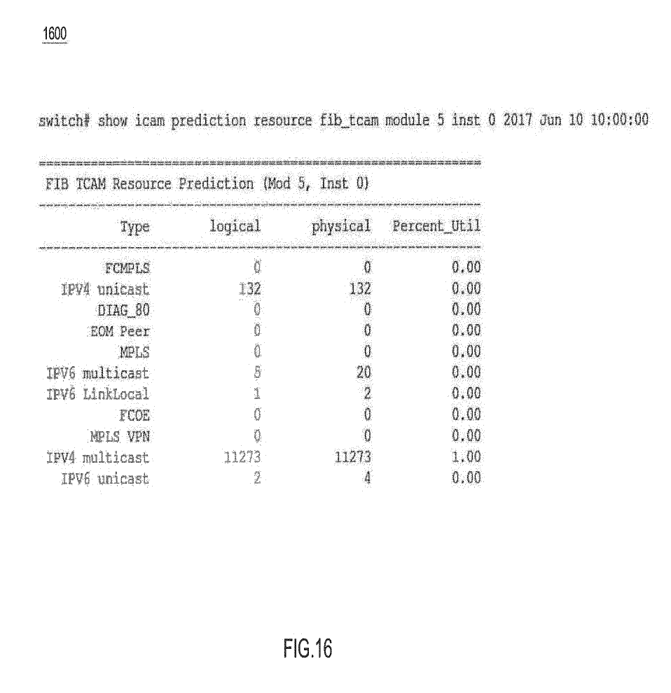

FIG. 16 shows an example of predicted forwarding information base (FIB) data 1600.

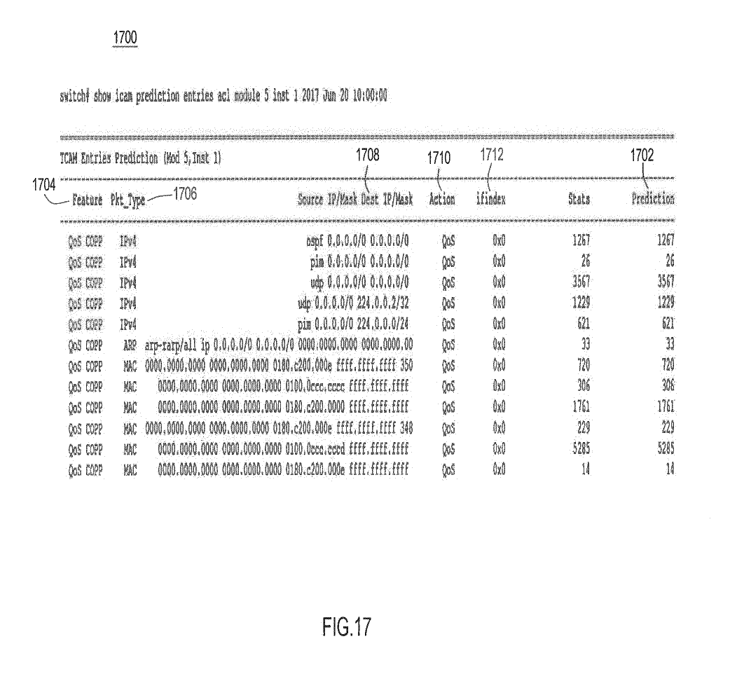

FIG. 17 shows an example of a prediction of ACL entries. The example prediction of ACL entries 1700 includes a prediction of a packet count 1702 in the future (e.g., Jun. 20, 2017 at 10:00:00) for a corresponding feature 1704, packet type (pkt_type) 1706, source IP/Mask destination (dest) IP/mask 1708, action 1710, and if index 1712.

The prediction data may be further processed in various ways such as:
Filter the data by networking feature type
Sort the data in descending/ascending order by traffic statistics
Display only top or bottom X % of entries based on the traffic statistics

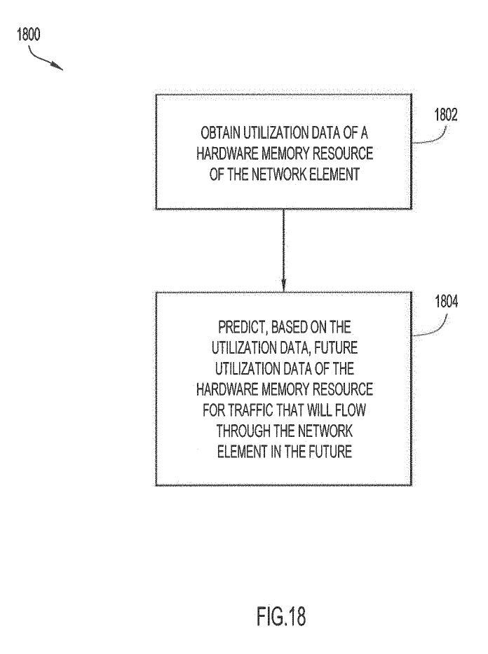

FIG. 18 is a flow chart of a method, according to an example embodiment. The method 1800 may be executed in a network clement (e.g., network element 110), which includes one or more hardware memory resources of fixed storage capacity, such as a TCAM. The one or more hardware memory resources are used to configure a plurality of networking features implemented on the network element. At 1802, utilization data of the one or more hardware memory resources is obtained.

At operation 1804, based on the utilization data, future utilization of the one or more hardware memory resources for traffic that will flow through the network element in the future is predicted.

In an example embodiment, the future utilization data may include at least one of per-entry traffic count or per-hardware-memory resource usage.

In an example embodiment, the utilization data may include at least one of per-entry traffic count or per-hardware-memory-resource usage.

In an example embodiment, the method may include determining an entropy for each distinct attribute subset of a set of attributes, and generating a decision tree based on the entropy; wherein predicting is further based on the decision tree.

In an example embodiment, the method may include generating, based on the future utilization data, configuration data, and automatically configuring, based on the configuration data, the network element.

In an example embodiment, predicting may include analyzing the utilization data with a machine learning algorithm. The machine learning algorithm may be the Iterative Dichotomiser 3 (ID3) algorithm.

In an example embodiment, the method may include generating a decision tree from the utilization data, Predicting may include, predicting the future utilization data based on the decision tree.

In an example embodiment, the determined attributes may include at least one of a source internet protocol (IP) address, a destination IP address, a month of a year, an hour of a day, or a packet type.

In an example embodiment, the method may include generating, based on the future utilization data, a configuration recommendation for the network element. The method may include modifying, based on the configuration recommendation, at least one networking feature of the network element.

In an example embodiment, the method may include sending the future utilization data to a network management application for display.

In an example embodiment, the utilization data may include a plurality of packet counts for traffic corresponding to a source internet protocol (IP) address and a destination IP address at respective times.

In an example embodiment, obtaining the utilization data may be based on received configuration input. The received configuration input may be indicative of at least one of a date or a time for which to predict future utilization data.

A network element includes one or more hardware memory resources of fixed storage capacity for storing data used to configure a plurality of networking features of the network element. Data predicting the usage of the fixed memory elements in the future is generated using machine learning techniques natively on the network element. For example, machine learning is used to predict “packet counters per TCAM entry”, that is, how much traffic (matching each hardware table entry) will be there in the future.

A network element includes one or more hardware memory resources of fixed storage capacity for storing data used to configure a plurality of networking features of the network element. Historical data about the usage of the fixed memory elements is stored in response to user configurations. For example, historical traffic analytics are generated, such as historical packet counters, for each hardware memory resource (e.g., ternary content addressable memory (TCAM) entry).

In one embodiment, a network element includes one or more hardware memory resources of fixed storage capacity for storing data used to configure a plurality of networking features of the network element. Historical data about the usage of the fixed memory elements is stored in response to user configurations. For example, historical traffic analytics are generated, such as historical packet counters, for each hardware memory resource (e.g., ternary content addressable memory (TCAM) entry).

In one embodiment, a network element includes one or more hardware memory resources of fixed storage capacity for storing data used to configure a plurality of networking features of the network element. Data predicting the usage of the fixed memory elements in the future is generated using, machine learning techniques natively on the network element. For example, machine learning is used to predict “packet counters per TCAM entry”, that is, how much traffic (matching each hardware table entry) will be there in the future.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
in a network element that includes one or more hardware memory resources of fixed storage capacity for storing data used to configure a plurality of networking features of the network element and a utilization management process running on the network element, the utilization management process performing operations including:
obtaining utilization data of a hardware memory resource of the network element; and
generating, based on the utilization data, historical utilization data of the hardware memory resource.

2. The method of claim 1, further comprising:
predicting, based on the utilization data accumulated over a period of time, future utilization data of the hardware memory resource for traffic that will flow through the network element in the future.

3. The method of claim 2, wherein predicting includes analyzing the utilization data with a machine learning algorithm.

4. The method of claim 2, further comprising:
generating a decision tree from the utilization data and one more determined attributes; and
wherein predicting comprises, predicting the future utilization data based on the decision tree.

5. The method of claim 4, wherein the determined attributes comprise at least one of a source internet protocol (IP) address, a destination IP address, a month of a year, an hour of a day, or a packet type.

6. The method of claim 2, further comprising:
generating, based on the future utilization data, configuration data; and
automatically configuring, based on the configuration data, the network element.

7. The method of claim 1, wherein the utilization data includes at least one of per-entry traffic count or per-hardware-memory-resource usage.

8. The method of claim 1, wherein the historical utilization data includes at least one of per-entry traffic count or per-hardware-memory-resource usage.

9. The method of claim 1, further comprising:
receiving a configuration of historical utilization data to be generated in the network element.

10. The method of claim 1, wherein the configuration includes at least one of a monitor interval, a number of intervals, or an interval duration.

11. The method of claim 1, wherein the configuration includes at least one of a class, a module, or an instance associated with the hardware memory resource.

12. The method of claim 1, wherein obtaining utilization data includes monitoring usage of the hardware memory resource for at least one of the networking features.

13. The method of claim 1, wherein obtaining utilization data includes monitoring usage of the hardware memory resource over a period of time.

14. An apparatus comprising:
one or more hardware memory resources of fixed storage capacity for storing data used to configure a plurality of networking features of the network element and a utilization management process running on a network element; and
a processor in communication with the one or more hardware memory resources, wherein the processor is configured to:
obtain utilization data of a hardware memory resource of the network element; and
generate, based on the utilization data, historical utilization data of the hardware memory resource.

15. The apparatus of claim 14, wherein the processor is further configured to:
predict, based on the utilization data, future utilization data of the hardware memory resource for traffic that will flow through the network element in the future.

16. The apparatus of claim 15, wherein the processor configured to predict includes the processor configured to analyze the utilization data with a machine learning algorithm.

17. The apparatus of claim 14, wherein the utilization data includes at least one of per-entry traffic count or per-hardware-memory-resource usage

18. One or more non-transitory computer readable storage media encoded with instructions that, when executed by a processor in a network element that includes one or more hardware memory resources of fixed storage capacity for storing data used to configure a plurality of networking features, cause the processor to:
obtain utilization data of a hardware memory resource of the network element; and
generate, based on the utilization data, historical utilization data of the hardware memory resource.

19. The non-transitory computer readable storage media of claim 18, wherein the instructions further cause the processor to:
predict, based on the utilization data, future utilization data of the hardware memory resource for traffic that will flow through the network element in the future.

20. The non-transitory computer readable storage media of claim 19, wherein the instructions further cause the processor to predict includes the instructions further cause the processor to analyze the utilization data with a machine learning algorithm.
